(19) United States
(12) Patent Application Publication
(10) Pub. No.: US 2025/0363522 A1
(43) Pub. Date: Nov. 27, 2025

(54) OUTCOME MEASUREMENT IN A CLEANROOM

(71) Applicant: VIDEOAMP, INC., Los Angeles, CA (US)

(72) Inventors: Keith David Landry, Culver City, CA (US); Michael Ethan Hankin, San Francisco, CA (US); James Robert Koehler, Boulder, CO (US); Kyle David Stock, Los Angeles, CA (US); Kathryn Elaine Mitchell, Austin, TX (US); Seyed Mahdi Sadjadi, Chicago, IL (US); Steven James Whalen, Los Angeles, CA (US); Pardeep Singh Banwait, Carteret, NJ (US); Ramzi Joseph Nasr, Cypress, CA (US)

(73) Assignee: VIDEOAMP, INC., Los Angeles, CA (US)

(21) Appl. No.: 19/216,598

(22) Filed: May 22, 2025

Related U.S. Application Data
(60) Provisional application No. 63/650,907, filed on May 22, 2024.

(51) Int. Cl. G06Q 30/0242

(52) U.S. Cl. CPC G06Q 30/0246

(57) ABSTRACT

A method may include obtaining a request from a user for an attribution report associated with an advertising campaign. The method may also include obtaining, by a cleanroom, first data from a first data source. The method may further include obtaining, by the cleanroom, second data from a second data source. The method may also include aggregating the first data and the second data in the cleanroom into aggregated data. The method may further include performing, within the cleanroom, a transformation on the aggregated data to obtain the attribution report. The method may also include providing the attribution report to the user.

### CROSS REFERENCE TO RELATED APPLICATIONS

This U.S. patent application claims priority to U.S. Provisional Patent Application No. 63/650,907, titled “OUTCOME MEASUREMENT IN A CLEAN ROOM,” and filed on May 22, 2024, the disclosure of which is hereby incorporated by reference in its entirety.

### TECHNICAL FIELD

This disclosure relates to outcome measurement in advertising, and more specifically, to outcome measurement in a cleanroom.

### BACKGROUND

Unless otherwise indicated herein, the materials described herein are not prior art to the claims in the present application and are not admitted to be prior art by inclusion in this section.

Digital advertising includes providing advertisements from advertising entities and/or digital publishers to consumers. Advertising may be in the form of linear advertising, streaming advertising, and/or digital advertising. In some instances, it may be beneficial to determine an effectiveness of an advertising campaign, which may be related to impressions associated with the advertisement of the advertising campaign and/or corresponding conversions.

Determining an effectiveness may be difficult where impression and/or conversion data may include or be limited by privacy restrictions. For example, conversion data may include privacy sensitive consumer data that the owner of the conversion data may not want to share and/or may be unable to share in view of privacy regulations.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a method may include obtaining a request from a user for an attribution report associated with an advertising campaign. The method may also include obtaining, by a cleanroom, first data from a first data source. The method may further include obtaining, by the cleanroom, second data from a second data source. The method may also include aggregating the first data and the second data in the cleanroom into aggregated data. The method may further include performing, within the cleanroom, a transformation on the aggregated data to obtain the attribution report. The method may also include providing the attribution report to the user.

In another embodiment, a system may include one or more non-transitory computer-readable storage media configured to store instructions. The system may also include one or more processors communicatively coupled to the one or more non-transitory computer-readable storage media and configured to, in response to execution of the instructions, cause the system to perform operations. The operations may include obtaining a request from a user for an attribution report associated with an advertising campaign. The operations may also include obtaining, by a cleanroom, first data from a first data source. The operations may further include obtaining, by the cleanroom, second data from a second data source. The operations may also include aggregating the first data and the second data in the cleanroom into aggregated data. The operations may further include performing, within the cleanroom, a transformation on the aggregated data to obtain the attribution report. The operations may also include providing the attribution report to the user.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates a block diagram of an example system for outcome measurement in a cleanroom;

FIG. 2 illustrates a block diagram of an example flow for outcome measurement using a cleanroom;

FIG. 3 illustrates a block diagram of an example flow associated with a cleanroom;

FIG. 4 illustrates a flowchart of an example method of outcome measurement in a cleanroom; and

FIG. 5 illustrates an example computing device.

### DETAILED DESCRIPTION

Determining an effectiveness of an advertising campaign may include determining consumer impressions associated with an advertisement of the advertising campaign. Alternatively, or additionally, the effectiveness of the advertising campaign may include determining conversions associated with the advertising campaign and/or associated with the consumer impressions. In some instances, the consumer impressions and/or the conversions may be and/or may include privacy sensitive data. Alternatively, or additionally, in some instances, one or more entities that have obtained the consumer impressions and/or the conversions may limit sharing thereof in the absence particular privacy protections.

Aspects of the present disclosure describe a system and method that may determine impressions and/or conversions associated with an advertising campaign, while maintaining sensitive data associated with the impressions and/or conversions in a privacy protected environment. In some instances, a cleanroom may be utilized to facilitate data transfer, data sharing, and/or other exchange of data while maintaining privacy for the data in the cleanroom and restricting access to the data in the cleanroom to requesting entities that have been granted access to the data in the cleanroom. As described herein, one or more reports associated with the advertising campaign may be generated and/or provided using the impression data and/or the conversion data for entities that may have been granted access to the impression data and/or the conversion data.

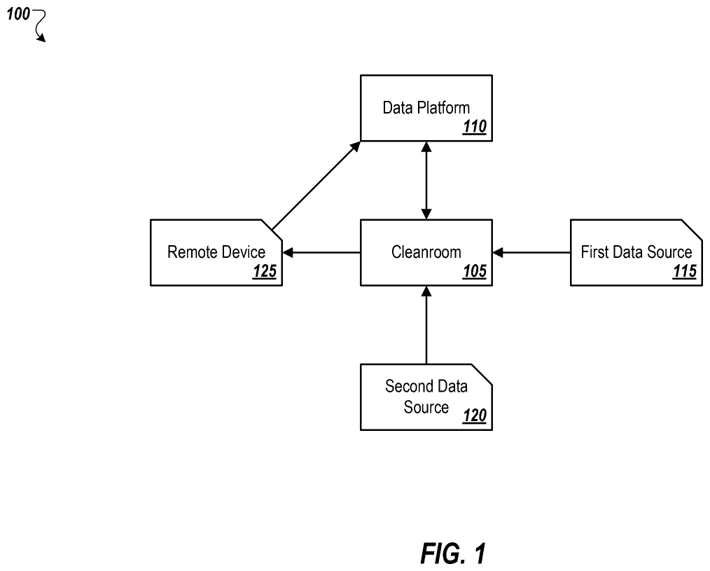

FIG. 1 illustrates a block diagram of an example system 100 for outcome measurement in a cleanroom. The system 100 may include a cleanroom 105 and a data platform 110. In some instances, the system 100 may be operable to determine an effectiveness and/or outcomes associated with an advertising campaign, while maintaining privacy for the underlying data associated with the advertising campaign, including the consumers targeted by the advertising campaign. In some instances, the advertising campaign may be delivered to the consumers in the form of linear advertising, streaming advertising, digital advertising, or any type of advertising, and/or any combination thereof. In some instances, the system 100 may be operable to provide on-demand access to at least the first data source 115 and/or the second data source 120 (which may include data sources of varying types), improvements to understanding incrementality and/or seasonality relative to a product, generated reports detailing whether competitive share may change, and/or creating product level and/or category level benchmarks for conversions. In the present disclosure, a conversion may be an action taken by a consumer, which may or may not be related to viewing the advertisement of the advertising campaign.

In some instances, the cleanroom 105 may be configured to act as a shared data space with restricted access. The cleanroom 105 may refer to an environment where some or all data may be anonymized, aggregated, processed, and/or stored to be made available for measurement, and/or data transformations in a privacy-focused way. For example, the first data source 115 and the second data source 120 may desire to share their respective data corpora with one another. The first data source 115 and the second data source 120 may then enter into a contract or agreement to share data. Responsive to receiving a request from the first data source 115 and the second data source 120 to create or join the cleanroom 105, the cleanroom 105 may be created and used by the first data source 115 and the second data source 120. The cleanroom 105 may be accessed using one or more of a service account and/or an encryption key. The cleanroom 105 may include some or all of the respective data corpora from both the first data source 115 and the second data source 120. Access to the cleanroom 105 may be restricted in any manner. In some examples, the access may be restricted using the service account. A service account may refer to a specific account that has been created for the purpose of accessing a particular shared data space. Additionally or alternatively, access to the cleanroom 105 may be restricted using the encryption key. The encryption key, for example, may limit access only to entities (e.g., the first data source 115 and the second data source 120) that may have entered into a contract with one another, and may be generated using any method of encryption for encrypting data. Further, an encryption key may only provide one-way access to the entities that have access to the key. The first data source 115 and the second data source 120 that have an encryption key and access to the cleanroom 105 may desire to have additional entities (e.g., other data sources) and their data corpora joined to the cleanroom 105. In such a scenario, a third data source (not illustrated) may be provided an encryption key that may grant access to the cleanroom 105 already created for use by the first data source 115 and the second data source 120. In some instances, the encryption key may be shared after permission is given by the entities (e.g., the first data source 115 and the second data source 120) that currently have access to the encryption key.

In some instances, the data platform 110 may be a computing device, system, and/or application that may be operable to interface with the cleanroom 105. In some instances, the data platform 110 may be operable to utilize the cleanroom 105 to bypass restrictions that may be included on individual level data (e.g., data belonging to an individual and not included in an aggregate). For example, operations may be performed by the data platform 110 within the cleanroom 105 (where data stored therein may be anonymized) and subsequently extracted in an aggregate form, thus maintaining the anonymity of the data within the cleanroom 105. Using the workflow and/or methodology described herein, the data platform 110 may be operable to provide on-demand outcome measurement using the cleanroom 105.

In some instances, the data platform 110 may be operable to obtain a user request for an attribution report. In some instances, the user request may be generated using a remote device 125. For example, the data platform 110 may use one or more external application programming interfaces (APIs) to obtain one or more user requests for an attribution report from the remote device 125. Stated another way, the one or more APIs associated with the data platform 110 may be operable to obtain one or more attribution reports and/or any other data associated with the attribution reports based on a user request, such as from the remote device 125.

In some instances, the data platform 110 may identify a type of report and/or a panel to be obtained from the cleanroom 105 and corresponding to the requested attribution report from the user of the remote device 125. In some instances, a type of report may indicate a data source that may be used. In some instances, the data source to be used may include a standard pixel inclusion, where the data source associated with the outcomes may map to the data type, and so forth. The panel may be set up in advance of an invocation of a particular API, such as a requirements management (RM) API.

In response to obtaining the user request for an attribution report, the cleanroom 105 may begin an attribution process. The attribution process may include running a workflow that may include operations within the cleanroom 105. In some instances, the workflow may be based on a defined interface that may invoke a co-created template. A co-created template may be a template developed using the data platform 110 and/or may be based on a customer request and/or customer preferences that may be related to the data included in the attribution report. In some instances, the conversion methodology used in the attribution process may be performed using a rule based attribution (RBA) approach and/or an incrementality approach. The conversion methodology may include other rule-based attribution approaches and/or model-based attribution approaches.

In some instances, the cleanroom 105 may be operable to write outputs to an intermediary place. The intermediary place may be selected to process the attribution report generated by the cleanroom 105. In some instances, the intermediary place may be an output table of aggregated data obtained from the cleanroom 105.

In some instances, the data platform 110 may be operable to perform a stacking operation and/or may generate an end report based on the attribution report obtained from the cleanroom 105. In some instances, the data platform 110 may be operable to perform one or more transformations on the aggregated data that may be included in the end report. Alternatively, or additionally, the data platform 110 may be operable to determine a number of conversions that may be associated with the advertising campaign, as included in the attribution report. In some instances, the data platform 110 may be operable to transmit the results to the user (e.g., via the remote device 125) in response to the user request. The results may be delivered to the user in various packages, such as a user platform, a custom user interface, a user API, and/or other deliverables to the user.

Modifications, additions, or omissions may be made to the system 100 without departing from the scope of the present disclosure. For example, the designations of different elements in the manner described is meant to help explain concepts described herein and is not limiting. Further, the system 100 may include any number of other elements or may be implemented within other systems or contexts than those described. For example, any of the components of FIG. 1 may be divided into additional or combined into fewer components.

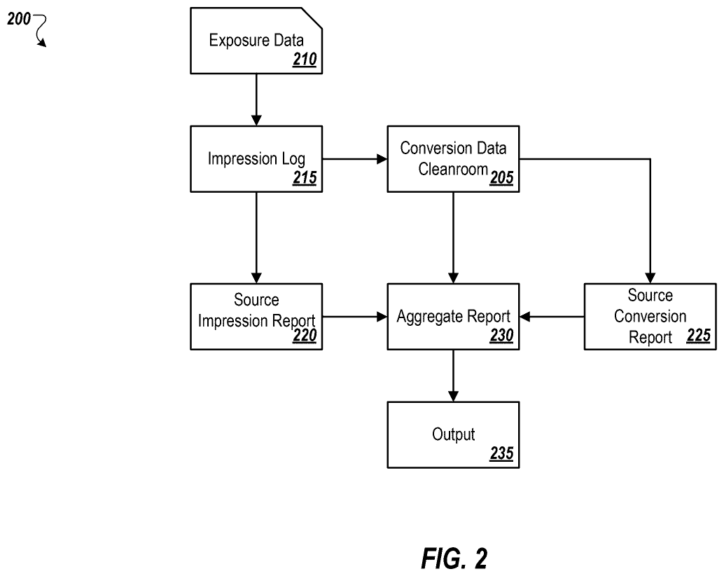

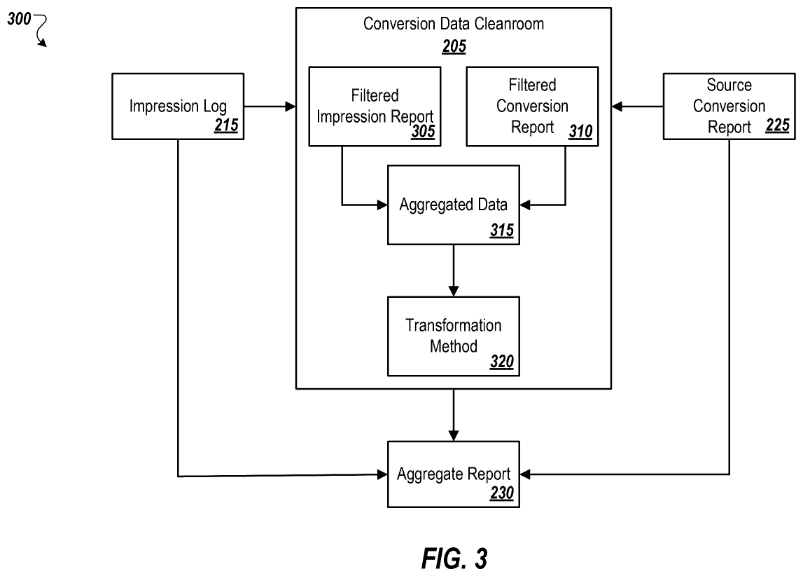

FIG. 2 illustrates a block diagram of an example flow 200 for outcome measurement using a cleanroom. FIG. 3 illustrates a block diagram of an example flow 300 associated with a cleanroom, which may include a detailed view of a portion of the flow 200. The flow 200 may include a conversion data cleanroom 205 (or cleanroom 205), an impression log 215, a source impression report 220, a source conversion report 225, an aggregate report 230, and an output 235. The flow 300 may include a filtered impression report 305, a filtered conversion report 310, aggregated data 315, and a transformation method 320.

In some instances, the flow 200 may illustrate interactions between data inside the cleanroom 205 and data that may be outside the cleanroom 205 (e.g., impression data and/or conversion data). For example, in some instances, impression data may be disposed without the cleanroom 205 (e.g., the impression log 215 may be obtained based on impression data disposed without the cleanroom 205) and conversion data may be disposed within the cleanroom 205 (e.g., the source conversion report 225 may be generated based on conversion data disposed within the cleanroom 205). In some instances, the flow 300 may illustrate operations and/or data management within the cleanroom 205.

In some instances, exposure data 210 may be obtained, such as by a data platform (e.g., the data platform 110 of FIG. 1), where the exposure data 210 may be disposed without the cleanroom 205. In some instances, the exposure data 210 may be obtained from linear content (e.g., automatic content recognition (ACR) and/or set-top-box (STB)), digital pixels, digital partner integrations, and/or other cleanrooms. In some instances, the exposure data 210 may be generated from a data source associated with a website visit and/or user interactions with the website. For example, the exposure data 210 may include a results generated by a user query on the website and/or a user query entered into an application.

In some instances, the exposure data 210 may be used to generate the impression log 215, and in some instances, the impression log 215 may be input to the cleanroom 205. Alternatively, or additionally, the impression log 215 may be used by the data platform to generate the source impression report 220. The source impression report 220 may include reach numbers after applying a scaling function for a given currency grade dataset, where the scaling function may be operable to scale reach and/or impressions from matched reach and impressions to source reach and impressions. Alternatively, or additionally, the source impression report 220 may include source impressions for a given currency grade dataset. In some instances, a currency grade dataset may be obtained from curated data obtained from one or more sources by the data platform, where the curated data may be aggregated into a measurable sample and/or weighted sample by the data platform.

In some instances, the cleanroom 205 may use the impression log 215 to generate the filtered impression report 305. In some instances, the cleanroom 205 may be operable to generate the filtered conversion report 310. The filtered impression report 305 and/or the filtered conversion report 310 may individually be associated with a custom panel, where the custom panel may include one or more household identifiers that may be weighted and/or used for the aggregate report 230.

In some instances, the cleanroom 205 may utilize the filtered impression report 305 and/or the filtered conversion report 310 to create a rules-based dataset and/or a lift dataset. Alternatively, or additionally, the cleanroom 205 may perform the transformation method 320, which may include operations performed in the cleanroom 205 and/or operations performed in a second cleanroom. The transformation method 320 may be performed on identified household (HH) level data. In some instances, the transformation method 320 may include a rules-based model, conversion participation, and/or an incrementality model.

In some instances, the cleanroom 205 may output the source conversion report 225. Alternatively, or additionally, the cleanroom 205 may output results from the transformation method 320 described herein (e.g., output based on the rules-based model, the conversion participation, and/or the incrementality model). The data platform may be operable to use the source conversion report 225, the source impression report 220, and/or the output results from the transformation method 320 to generate the aggregate report 230. The data platform may be operable to make adjustments to the aggregate report 230, such as scaling any of the results in the aggregate report 230 for any missing identities (e.g., scaling the results in the aggregate report 230 to match source conversions), performing thresholding (e.g., confirming whether a threshold number of conversions, such as on a household scale, may have occurred to satisfy a minimum number for performing the outcome measurement as described herein), scaling based on the impression panel, etc. In some instances, the data platform may be operable to output 235 the results of the aggregate report 230 to an API, such as an internal API.

In these and other instances, aspects of the present disclosure may provide on-demand access to the outcome data for mutually agreed upon use cases. The mutually agreed upon use cases may include an agreement between at least the data platform and the user on one or more aspects related to the data and/or obtaining the data, such as at least data sources that may be utilized for the user and/or data sources that may be contracted by the user. Alternatively, or additionally, the methods described herein may implement a consistent methodology across various implementations in which the method may be applied. For example, cleanroom to cleanroom and/or cleanroom vs. non-cleanroom may each implement a consistent methodology.

In some instances, the methods described herein may perform direct match within the cleanroom 205, in order to facilitate bypassing identity third-parties, which may contribute to improving operations. As described, the conversion data within the cleanroom 205 may be accessed programmatically using API calls. Alternatively, or additionally, redundancies in report computation and/or storage of multiple reports may be eliminated. In some embodiments, the cleanroom 205 may support multiple parties/entities, which may facilitate on-demand communications between interested parties (e.g., the user described herein) and the cleanroom 205. The methods described herein may be operable to enable advertiser's digital conversion pixel data sharing to permissioned networks and/or agencies with proper approvals access via the cleanroom 205. Alternatively, or additionally, the method may support the ability to externalize aggregated outcome data for benchmarking purposes.

Modifications, additions, or omissions may be made to the flow 200 and/or the flow 300 without departing from the scope of the present disclosure. For example, the designations of different elements in the manner described is meant to help explain concepts described herein and is not limiting. Further, the flow 200 and/or the flow 300 may include any number of other elements or may be implemented within other systems or contexts than those described. For example, any of the components of FIG. 2 and/or FIG. 3 may be divided into additional or combined into fewer components.

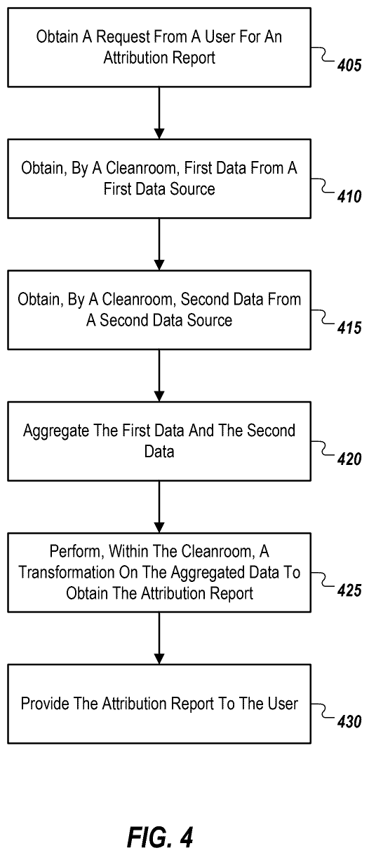

FIG. 4 illustrates a flowchart of an example method 400 of outcome measurement in a cleanroom. The method 400 may be performed by processing logic that may include hardware (circuitry, dedicated logic, etc.), software (such as is run on a general purpose computer system or a dedicated machine), or a combination of both, which processing logic may be included in any computer system or device, such as the cleanroom 105 or the data platform 110 of FIG. 1.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At block 405, a request from a user for an attribution report associated with an advertising campaign may be obtained.

At block 410, first data from a first data source may be obtained. In some instances, the first data may be obtained by the cleanroom. In some instances, the first data may include impressions associated with a consumer viewing an advertisement of the advertising campaign. Alternatively, or additionally, in some instances, the first data source may be linear content data.

At block 415, second data from a second data source may be obtained. In some instances, the second data may be obtained by the cleanroom. In some instances, the second data may include conversions associated with the advertising campaign. In some instances, the second data source may be configured to measure consumer conversions associated with the advertising campaign.

At block 420, the first data and the second data may be aggregated in the cleanroom to become aggregated data. In some instances, the first data and/or the second data may be privacy sensitive data associated with one or more consumers targeted by the advertising campaign.

At block 425, a transformation on the aggregated data may be performed to obtain the attribution report. In some instances, the transformation may be performed within the cleanroom.

At block 430, the attribution report may be provided to the user.

Modifications, additions, or omissions may be made to the method 400 as described without departing from the scope of the present disclosure. For example, in some instances, third data from a third data source may be obtained by the cleanroom. In some instances, the first data may be obtained at a first time and the third data may be obtained at a second time. Alternatively, or additionally, the first data may be combined with third data and the combination thereof may be included in the aggregated data. In some instances, the first data source may be the same as the third data source, and the first data may be obtained at a different time than the third data. Further, the method 400 may include any number of other elements or may be implemented within other systems or contexts than those described.

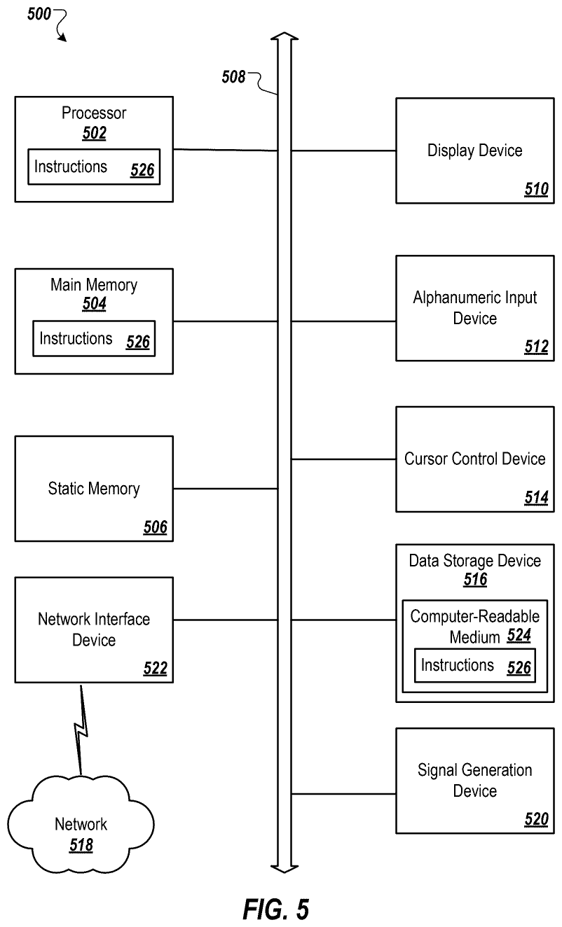

FIG. 5 illustrates an example computing device 500 within which a set of instructions for causing the machine to perform any one or more of the methods discussed herein may be executed. The computing device 500 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions for causing the machine to perform any one or more of the methods discussed herein may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 500 can include a processing device 502 (e.g., a processor), a main memory 504 (e.g., read-only memory (ROM), flash memory, dynamic random access memory (DRAM) such as synchronous DRAM (SDRAM)), a static memory 506 (e.g., flash memory, static random access memory (SRAM)) and a data storage device 516, which communicate with each other via a bus 508.

The processing device 502 represents one or more general-purpose processing devices such as a microprocessor, central processing unit, or the like. More particularly, the processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also include one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein.

The computing device 500 may further include a network interface device 522 which may communicate with a network 518. The computing device 500 also may include a display device 510 (e.g., a liquid crystal display (LCD) or a cathode ray tube (CRT)), an alphanumeric input device 512 (e.g., a keyboard), a cursor control device 514 (e.g., a mouse) and a signal generation device 520 (e.g., a speaker). In at least one implementation, the display device 510, the alphanumeric input device 512, and the cursor control device 514 may be combined into a single component or device (e.g., an LCD touch screen).

The data storage device 516 may include a computer-readable storage medium 524 on which is stored one or more sets of instructions 526 embodying any one or more of the methods or functions described herein. The instructions 526 may also reside, completely or at least partially, within the main memory 504 and/or within the processing device 502 during execution thereof by the computing device 500, the main memory 504 and the processing device 502 also constituting computer-readable media. The instructions may further be transmitted or received over the network 518 via the network interface device 522.

While the computer-readable storage medium 524 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding, or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

A number of implementations have been described. Nevertheless, it will be understood that various modifications may be made without departing from the spirit and scope of the disclosure. Accordingly, other implementations are within the scope of the following claims.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
obtaining a request from a user for an attribution report associated with an advertising campaign;
obtaining, by a cleanroom, first data from a first data source;
obtaining, by the cleanroom, second data from a second data source;
aggregating the first data and the second data in the cleanroom into aggregated data;
performing, within the cleanroom, a transformation on the aggregated data to obtain the attribution report; and
providing the attribution report to the user.

2. The method of claim 1, wherein the first data comprises impressions associated with a consumer viewing an advertisement of the advertising campaign.

3. The method of claim 1, wherein the first data source is linear content data.

4. The method of claim 1, further comprising obtaining, by the cleanroom, third data from a third data source.

5. The method of claim 4, wherein the first data is obtained at a first time and the third data is obtained at a second time.

6. The method of claim 4, wherein the first data is combined with third data and the combination is included in the aggregated data.

7. The method of claim 4, wherein the first data source is the same as the third data source, and the first data is obtained at a different time than the third data.

8. The method of claim 1, wherein the second data comprises conversions associated with the advertising campaign.

9. The method of claim 1, wherein the second data source is configured to measure consumer conversions associated with the advertising campaign.

10. The method of claim 1, wherein the first data and the second data is privacy sensitive data associated with one or more consumers targeted by the advertising campaign.

11. A system, comprising:
one or more non-transitory computer-readable storage media configured to store instructions; and
one or more processors communicatively coupled to the one or more non-transitory computer-readable storage media and configured to, in response to execution of the instructions, cause the system to perform operations, the operations comprising:
obtain a request from a user for an attribution report associated with an advertising campaign;
obtain, by a cleanroom, first data from a first data source;
obtain, by the cleanroom, second data from a second data source;
aggregate the first data and the second data in the cleanroom into aggregated data;
perform, within the cleanroom, a transformation on the aggregated data to obtain the attribution report; and
provide the attribution report to the user.

12. The system of claim 11, wherein the first data comprises impressions associated with a consumer viewing an advertisement of the advertising campaign.

13. The system of claim 11, wherein the first data source is linear content data.

14. The system of claim 11, wherein the operations further comprise obtain, by the cleanroom, third data from a third data source.

15. The system of claim 14, wherein the first data is obtained at a first time and the third data is obtained at a second time.

16. The system of claim 14, wherein the first data is combined with third data and the combination is included in the aggregated data.

17. The system of claim 14, wherein the first data source is the same as the third data source, and the first data is obtained at a different time than the third data.

18. The system of claim 11, wherein the second data comprises conversions associated with the advertising campaign.

19. The system of claim 11, wherein the second data source is configured to measure consumer conversions associated with the advertising campaign.

20. The system of claim 11, wherein the first data and the second data is privacy sensitive data associated with one or more consumers targeted by the advertising campaign.
